(19) United States
(12) Patent Application Publication
(10) Pub. No.: US 2008/0170524 A1
(43) Pub. Date: Jul. 17, 2008

(54) METHOD FOR IMPLEMENTING THE NETWORK SERVICE PROVIDER DOMAIN NAME DISCOVERY AND THE DEVICE THEREOF

(75) Inventors: Shujun DANG, Shenzhen (CN); Peng ZHANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/035,857

(22) Filed: Feb. 22, 2008

Related U.S. Application Data
(63) Continuation of application No. PCT/CN2006/001990, filed on Aug. 7, 2006.

(30) Foreign Application Priority Data
Aug. 23, 2005 (CN) 200510036667.8

(51) Int. Cl. H04B 7/00

(52) U.S. Cl. 370/310

(57) ABSTRACT

A method and a device for implementing Network Service Provider (NSP) realm discovery, which are designed to discover the NSP realm by the user equipment in wireless communication network. In the present invention, the network side notifies the user equipment of the NSP realm; the user equipment receives the realm notified by the network side and discovers the required NSP realm. The present invention can implement the NSP realm discovery

### CROSS-REFERENCE TO RELATED APPLICATIONS

This application is a continuation of International Patent Application No. PCT/CN2006/001990, filed Aug. 7, 2006, which claims priority to Chinese Patent Application No. 200510036667.8, filed Aug. 23, 2005, both of which are hereby incorporated by reference.

### FIELD OF THE INVENTION

The present invention relates to access techniques in a wireless communication network, particularly to a method and device for implementing network service provider (NSP) domain name discovery in the wireless communication network when a user equipment accesses the network.

### BACKGROUND OF THE INVENTION

As wireless communication techniques develop, wireless communication networks are emerging in new forms, such as the Worldwide Interoperability for Microwave Access (WiMax) network, defined by WiMax Forum, and Wireless Local Area Network (WLAN). Usually, such a wireless communication network includes a user equipment, a Network Access Providers (NAP) and a Network Service Providers (NSP) composed by different operators. For example, in the case of WiMax networks, based on IEEE (The Institute of Electrical and Electronics Engineers) 802.16 standard, WiMax networks provide a high access rate.

FIG. 1 shows a schematic diagram of a reference model of WiMax network in a non-roaming condition. In the non-roaming condition, an Access Service Network (ASN) 110 is connected to a Connection Service Network (CSN) 120, and a Subscriber Station/Mobile Subscriber Station (SS/MSS) 130 accesses the CSN 120 through the ASN 110.

FIG. 2 shows a schematic diagram of the reference model of WiMax network in a roaming condition. In the roaming condition, the ASN 110 is connected to a Visited CSN 121. The Visited CSN 121 is connected to a Home CSN 122. The SS/MSS 130 is authenticated by the Home CSN 122 through the ASN 110 and the Visited CSN 121, and enjoys the services provided by the Visited CSN 121 and the Home CSN 122.

Usually, ASN is operated by NAP, and CSN is operated by NSP. For example, in an actual deployment, the NAP, Visited NSP, and Home NSP may be different operators. A n area may be covered by multiple ASNs, and each ASN may be connected to multiple NSP networks. For example, there are two deployment models for WiMax network at present: one is “NAP+NSP” model, i.e. the NAPs and the NSPs are in one-to-one mapping relationship; the other is “NAP Sharing” model, i.e. an NAP is mapped to multiple NSPs, and shared by the NSPs.

A simplified deployment model for WiMax network is shown in FIG. 3.

An ASN 111 of NAP_4 and an ASN 112 of NAP_6 cover a same area. A CSN 1201 of NSP_1, a CSN 1202 of NSP_2, and a CSN 1203 of NSP_3 share the ASN 111 of NAP_4; the ASN 112 of NAP_6 is bound with a CSN 1204 of NSP_6; the SS/MSS 131 and 132 access the network through ASN 111 and 112, respectively.

In an ASN Sharing model, there is a problem for a user equipment, as to how to know which NSPs share a current ASN, in other words, which NSPs can be accessed via the current ASN. It is the problem of choosing NSPs in wireless communication network, i.e. how the network side provide the information of currently available networks to a user equipment, so that the user equipment can obtain the information on all NSP networks accessible from the current location, then access an appropriate network.

Usually, four stages may be needed for the user equipment to choose an appropriate network to access:

Stage of NAP discovery: the SS/MSS discovers all NAP networks accessible from the current location, in condition that the current location of the SS/MSS is in coverage of these NAP networks.

Stage of NSP list discovery for current NAP: for each NAP network accessible from the current location, discover all NSPs accessible from the NAP.

Stage of obtaining all NSPs currently accessible and choosing an NSP: include all NSPs accessible from the current location of the SS/MSS in an NSP List, and choose an appropriate NSP from the list on the basis of a set of rules.

Stage of processing a network access to the chosen NSP: choose an appropriate NAP for the chosen NSP in condition that an NSP can be accessed via more that one NAPs, and initiate a network access process.

In the current IEEE 802.16g Specification, an NSP identity is provided to the SS/MSS by defining the following attributes, such as Type, Length, Value (TLV):

TABLE 1
Attributes to Service Identity Information (SII) TLV

| Name | Type | Length | Value | Scope |
|---|---|---|---|---|
| SII TLV | | 3*n | One or more | SBC_RSP |
| | | | 24-bit NSP IDs | |

TABLE 2
Attributes to NSP List TLV

| Name | Type | Length | Value | Scope |
|---|---|---|---|---|
| NSP List | | 3*n | One or more | SII Message |
| | | | 24-bit NSP IDs | |

In the second stage of network discovery and selection, the above two TLVs are used for providing the attributes in the NSP List to the SS/MSS. The NSP ID in the above two TLVs is a 24-bit ID in a string format.

### SUMMARY OF THE INVENTION

The present invention provides a method and a device for discovering NSP domain name, which can effectively and reliably discover NSP domain name.

A device for implementing network service provider (NSP) domain name discovery, includes:

a realm receiving unit, configured to receive realms of one or more NSPs from a network side; and

a realm discovering unit, configured to choose the realm of a required NSP from the received realms of one or more NSPs.

The device further includes: a realm query request constructing unit, configured to construct an NSP realm query request to be initiated to the network side.

The device further includes: a realm storing unit, configured to store the received realms of one or more NSPs, or to store the chosen realm of the required NSP.

A device for implementing network service provider (NSP) domain name discovery, includes:

a realm querying unit, configured to map one or more NSP IDs into one or more realms of corresponding NSPs; and

a realm information notifying unit, configured to send the mapped realms of corresponding NSPs obtained from the realm querying unit.

The device further includes: a realm query request resolving unit, configured to resolve a received NSP realm query request and to trigger the realm querying unit.

Compared with the prior art, the present invention has the following benefits:

In the present invention, the network side notifies the user equipment of the NSP realm name, the user equipment receives the NSP realm name notified by the network side, and discover the required NSP realm name. In the actual implementation, the network side can broadcast the NSP realm name actively, or the user equipment can initiate a query for the NSP realm name, so that the NSP realm name can be discovered effectively and reliably.

### BRIEF DESCRIPTION OF THE DRAWINGS

FIG. 1 is a schematic diagram of a reference model of WiMax network in a non-roaming condition;

FIG. 2 is a schematic diagram of a reference model of WiMax network in a roaming condition;

FIG. 3 is a schematic diagram of a deployment model of WiMax network;

FIG. 4 is a flow diagram of an embodiment of the method for implementing NSP domain name discovery in the present invention; and

FIG. 5 is a flow diagram of another embodiment of the method for implementing NSP domain name discovery in the present invention.

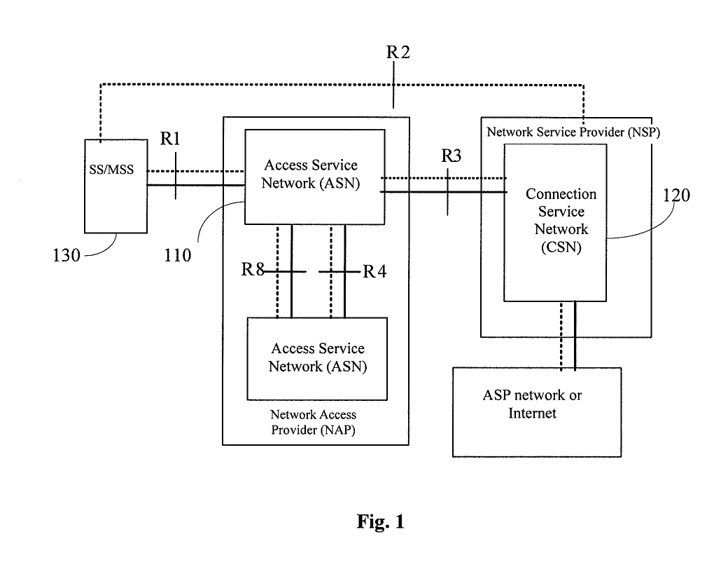

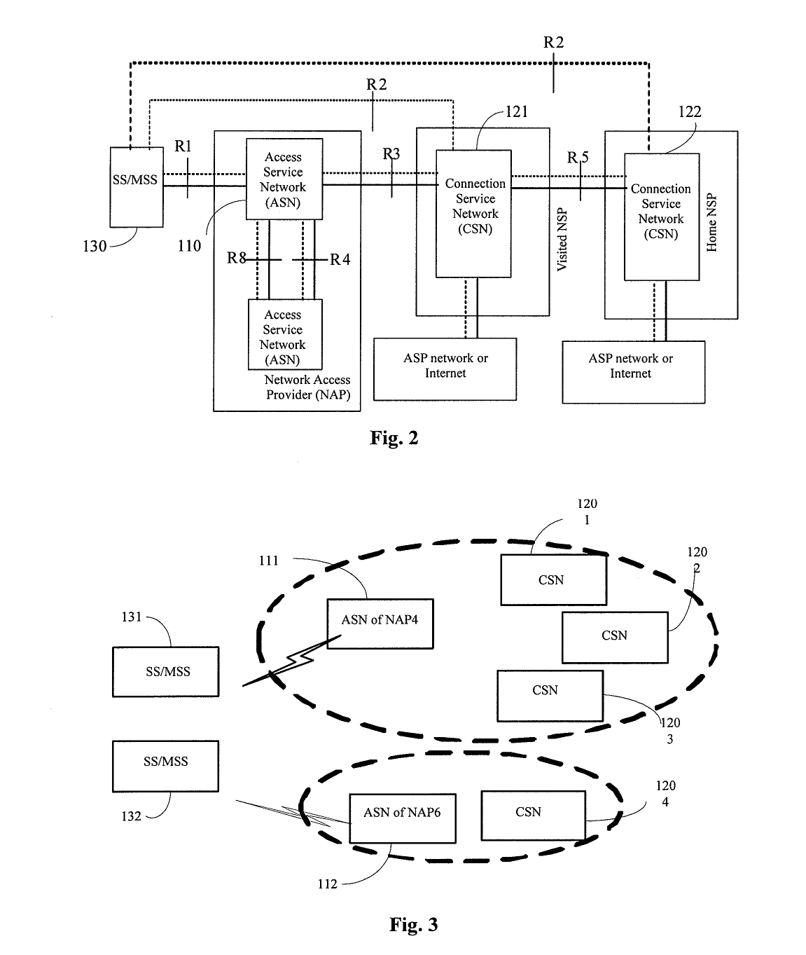

### DETAILED DESCRIPTION OF THE EMBODIMENTS

When a subscriber chooses an NSP to access (i.e. in the fourth stage of network discovery and selection, stage of processing a network access to the chosen NSP), the subscriber should construct the Network Access Identifier (NAI) with an NSP domain name (an NSP domain name is often named ‘realm’ for it is often in the realm format), so as to route an Authentication, Authorization and Accounting (AAA) message.

An NSP realm is a subscriber-readable identifier that identifies the NSP identity, such as wimax.operatorname.org. An NAI is an identifier that identifies the subscriber's identity, for example, username@realm. An AAA proxy between the subscriber and the AAA server in the subscriber's home network routes AAA messages by means of the domain name.

However, a 24-bit NSP ID can't be used to route AAA messages in the conventional technology, which is to say, it is hard to discover NSP domain name in an access process.

In the present invention, the network side notifies a user equipment of the NSP domain name (realm). After the user equipment receives the NSP realm notified by the network side, the user equipment discovers the required NSP realm. Wherein, the network side can actively or passively notify the user equipment of the NSP realm. Hereunder the embodiments of the present invention will be described.

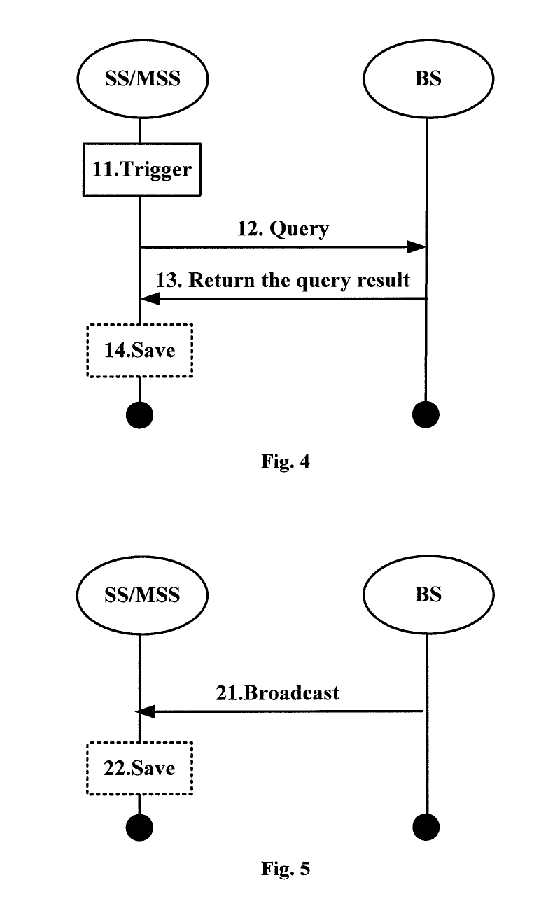

FIG. 4 shows a flow diagram of one embodiment of the method for implementing NSP realm discovery in the present invention. The main process is described as follows:

Step 11: A query for the NSP ID in the realm format in an SS/MSS is triggered.

For example, when an SS/MSS receives a 24-bit NSP ID which can't be recognized locally (the 24-bit NSP ID may be in an SII TLV from an SBC_RSP message or an SII message, the 24-bit NSP ID may also be in NSP list), the SS/MSS determines whether the 24-bit NSP ID can be mapped into a NSP realm locally. If the 24-bit NSP ID cannot be mapped into an NSP realm locally, the SS/MSS triggers a query. If the 24-bit NSP ID can be mapped into an NSP realm locally, it may terminate the process.

The mapping can be implemented with a variety of ways. For example, the SS/MSS may store a mapping table for the mapping relationship between the 24-bit NSP ID and NSP ID in the realm format (NSP realm). When the SS/MSS determines the 24-bit NSP ID may not be mapped directly into an NSP ID in the realm format locally, it will trigger (or the user will manually trigger) a query for the NSP realm corresponding to the 24-bit NSP ID.

Step 12: The SS/MSS initiates a query to a BS.

In the query process, the 24-bit NSP ID is carried in an uplink message sent from the user equipment.

In a specific implementation, the NSP ID to be mapped into the realm format can be carried in the query request message. For example, the query can be implemented with the attributes (TLV) shown in Table 3.

TABLE 3

| Name | Length | Value |
|---|---|---|
| Realm Query | 3*n | Including one or more 24-bit NSP IDs |

For example, a Realm Query attribute can be carried in a SBC_REQ message, to query for the NSP realm corresponding to the 24-bit NSP ID.

It is noted that, if more than one 24-bit NSP IDs needs to be queried, they can be handled one by one as step 12 may be repeated; or the NSP realm corresponding to the NSP IDs may be queried for in one-off.

Or, in the query process, the SS/MSS may send an uplink message to the network side with a specific request ID (for example for one bit) to request the relationship between all or a part of the 24-bit NSP IDs and the corresponding NSP realms.

Step 13: Through the network side, the BS returns a downlink message including the requested NSP realm, which refers to the NSP realm corresponding to the 24-bit NSP ID.

In a specific implementation, the NSP realm may be notified to the SS/MSS by means of the attributes shown in Table 4.

TABLE 4

| Name | Length | Value |
|---|---|---|
| Realm | Variable | Including one or more NSP IDs in the realm |
| | | format |

For example, the attributes of the realm can be carried in a SBC_RSP message in the downlink message.

Or, the network side may send to the SS/MSS the mapping relationship between all of or a part of the 24-bit NSP IDs and the corresponding NSP realms.

In the query process, the BS can utilize the NSP-realm-name configuration information stored locally (configured in advance, or configured dynamically by the network management system). Or the BS query for the NSP realm from an external entity, so as to map the 24-bit NSP ID into the NSP realm in the realm format.

Step 14: The SS/MSS stores the information of the NSP realm obtained in step 13 in a local configuration file.

Step 14 is optional.

Refer to FIG. 5, which is a flow diagram of another embodiment of the method for implementing NSP domain name (realm) discovery in the present invention. The main process is described as follows:

Step 21: At the network side, a BS broadcasts the NSP realm corresponding to the 24-bit NSP ID to a SS/MSS periodically or aperiodically.

Specifically, for example, the BS periodically or aperiodically broadcasts the Realm attributes in a downlink message. For example, the Realm attributes may be carried in SII messages. The format of the Realm attributes is shown in Table 5:

TABLE 5

| Name | Length | Value |
|---|---|---|
| Domain Name | Variable | Including 24-bit NSP ID and corresponding |
| | | NSP ID in the realm format |

In addition, the attributes of a 24-bit NSP ID can be in the format shown in Table 6:

TABLE 6

| Name | Length | Value |
|---|---|---|
| NSP ID | 3 | Including 24-bit NSP ID |

The attributes of a NSP realm in the realm format can be in the format shown in Table 7:

TABLE 7

| Name | Length | Value |
|---|---|---|
| NSP realm | Variable | Including NSP ID in realm format |

Step 22: The SS/MSS stores the obtained the information of the NSP realm in a local configuration file.

Step 22 is optional. In this case, the SS/MSS utilizes the received broadcast message to accomplish a conversion. When the broadcast message is not stored locally, the information received in the current process can't be used in subsequent conversions. When a conversion is required next time, the SS/MSS may monitor the broadcast message.

In one embodiment of the present invention, a device for implementing NSP realm discovery may include:

a realm receiving unit, configured to receive an NSP realm from the network side;

a realm discovering unit, configured to discover a required NSP realm from the received NSP realm.

The device may further include a realm query request constructing unit configured to construct an NSP realm query request to be initiated to the network side.

The units can be implemented and the working procedures can be understood in combination with the above-mentioned embodiments.

The device described in this embodiment may be arranged in the user equipment.

In another embodiment of the present invention, a device for implementing NSP realm discovery may includes:

a realm querying unit, configured to query for an NSP realm corresponding to an NSP ID;

a realm notifying unit, configured to obtain the NSP realm corresponding to the query from the realm querying unit, and send the information of the NSP realm;

a realm query request resolving unit, configured to resolve a received NSP realm query request and trigger the realm querying unit.

The realm querying unit may query for a realm actively. The realm notifying unit may broadcast the information of the realm.

The device described in this embodiment may be arranged in an appropriate device at the network side.

It is noted that the units in the above embodiments can be separated ones, or can be combined freely.

While the present invention has been illustrated and described in combination with some exemplary embodiments, the present invention is not limited to these. Those skilled in the art should recognize that various variations and modifications can be made without departing from the principle and scope of the present invention as defined by the accompanying claims.

What we claim is:

1. A method for implementing network service provider (NSP) domain name discovery, comprising:
notifying realms of one or more NSPs, by a network side, to a user equipment,
wherein the user equipment chooses a required realm of an NSP from the realms of one or more NSPs.

2. The method according to claim 1, wherein notifying the realms of one or more NSPs further comprises:
receiving, by a base station (BS) at the network side, an NSP realm query request from the user equipment;
sending, by the BS at the network side, the realms of one or more NSP requested by the user equipment.

3. The method according to claim 2, wherein the NSP realm query request carries one or more 24-bit NSP IDs; and
wherein sending to the user equipment the NSP realm requested by the user equipment further comprises:
mapping the one or more 24-bit NSP IDs into one or more realms of corresponding NSPs; and
returning, by the BS at the network side, the one or more realms of corresponding NSP to the user equipment.

4. The method according to claim 3, wherein the NSP realm query request is conveyed by an uplink message sent from the user equipment; and
wherein the one or more realms of corresponding NSP are carried in a downlink message sent from the network side.

5. The method according to claim 4, wherein the uplink message is a subscriber basic capability request (SBC_REQ) message; and
wherein the downlink message is a subscriber basic capability response SBC_RSP message or a service identity information (SII) message.

6. The method according to claim 3, wherein, the NSP realm query request is sent from the user equipment when the one or more 24-bit NSP IDs are unavailable to be mapped into the one or more realms of corresponding NSPs locally.

7. The method according to claim 3, wherein the query request carries a request ID,
wherein mapping the one or more 24-bit NSP IDs into one or more realms of corresponding NSPs further comprises:
mapping, by the network side, all or part of the 24-bit NSP IDs into the realms of corresponding NSPs according to the request ID.

8. The method according to claim 3, wherein the mapping relationship between the 24-bit NSP IDs and realms of corresponding NSPs is obtained from configuration information stored locally at the network side or by non-locally querying.

9. The method according to claim 3, further comprising:
storing the mapping relationship between the 24-bit NSP IDs and realms of corresponding NSPs locally, by the user equipment.

10. The method according to claim 1, further comprises, broadcasting, by the network side, the mapping relationship between the realms of one or more NSPs and the corresponding NSP IDs.

11. The method according to claim 10, wherein the corresponding NSP IDs are 24-bit NSP IDs;
the method further comprising:
storing the mapping relationship between the 24-bit NSP IDs and realms of corresponding NSPs locally, by the user equipment.

12. A method for implementing network access, comprising:
choosing an NSP to be accessed, by a user equipment;
obtaining a realm of corresponding NSP to an ID of the NSP, by the user equipment;
constructing a network access ID with the realm of corresponding NSP; and
routing an AAA message through the network access ID.

13. The method according to claim 12, wherein the user equipment obtains the realm of corresponding NSP to the NSP ID by local mapping; or
wherein the user equipment obtains a realm of corresponding NSP to the NSP ID in a broadcast message from the network side; or
the method further comprising:
initiating an NSP realm query request, by the user equipment, to the network side;
receiving, by the user equipment, the realm of corresponding NSP from the network side.

14. The method according to claim 12, further comprising:
storing, by the user equipment, the realm of corresponding NSP locally.

15. A device for implementing network service provider (NSP) domain name discovery, comprising:
a realm receiving unit, configured to receive realms of one or more NSPs from a network side; and
a realm discovering unit, configured to choose the realm of a required NSP from the received realms of one or more NSPs.

16. The device according to claim 15, further comprising:
a realm query request constructing unit, configured to construct an NSP realm query request to be initiated to the network side.

17. The device according to claim 15, further comprising:
a realm storing unit, configured to store the received realms of one or more NSPs, or to store the chosen realm of the required NSP.

18. A device for implementing network service provider (NSP) domain name discovery, comprising:
a realm querying unit, configured to map one or more NSP IDs into one or more realms of corresponding NSPs; and
a realm information notifying unit, configured to send the mapped realms of corresponding NSPs obtained from the realm querying unit.

19. The device according to claim 18, further comprising:
a realm query request resolving unit, configured to resolve a received NSP realm query request and to trigger the realm querying unit.
